(19) United States
(12) Patent Application Publication
(10) Pub. No.: US 2012/0162765 A1
(43) Pub. Date: Jun. 28, 2012

(54) PHOTOELECTRIC DEVICES HAVING INHOMOGENEOUS POLARIZATION SELECTIVITY AND THE MANUFACTURING METHOD THEREOF

(75) Inventors: Chung-Hao Tien, Hsinchu (TW); Tzu-Hsiang Lan, Hsinchu (TW); Jie-En Li, Hsinchu (TW)

(73) Assignee: National Chiao Tung University, Hsinchu (TW)

(21) Appl. No.: 13/169,250

(22) Filed: Jun. 27, 2011

(30) Foreign Application Priority Data
Dec. 27, 2010 (TW) 099146184

(51) Int. Cl. G02B 5/30; B23P 11/00

(52) U.S. Cl. 359/485.01; 359/483.01; 29/428

(57) ABSTRACT

The present invention provides an optical device having inhomogeneous polarization selectivity. The optical device includes a transparent substrate having a surface, a first optical element and a second optical element. The first and the second elements are disposed on the surface. The first optical element has a first polarization selectivity at least within a full visible frequency domain. The second optical element has a second polarization selectivity at least within a full visible frequency domain. The first and the second polarization selectivities have different orientations.

### FIELD OF THE INVENTION

The present invention relates to an optical device, particularly an optical device having inhomogeneous polarization selectivity and the manufacturing method thereof.

### BACKGROUND OF THE INVENTION

With the rapid development of photo-electric technologies, the industries have been more and more broadly making use of relevant applications of optical polarization. In the semiconductor process, for example, the photolithography process has been more complicated than ever. It is always an engineering issue on how to generate optical fields with inhomogeneous polarization, which may includes the cost issue and also the selectivity issue. In the field of the biomedical image inspection, the shape and the material of the specimen may cause interactions, such as absorption and scattering, with the incident lights, due to the miniaturation of the dimension of observation, says the dimension of nanometers. Under some application conditions, the orientation of polarization of the incident light needs to be in accordance with specific means. Besides, in the field of optical communication, with cost-effective method for achieving polarization over a full frequency domain to the incident light, some issues such as beam shaping can be handled conveniently, and the resolution as well as the contract of the light information would be increases. The light processed by particular inhomogeneous polarization may also be utilized in the field of fine art, with same as the concept of stained glass, to make a piece of art have various visual effects.

Optical devices for polarization known to the art include liquid crystal, grating thin-film, special crystal, optical films, and etc. However, liquid crystal and special crystal cannot provide wide-bandwidth and low-cost solutions, due to their high material-cost and only apply to the light with signal wavelength. The grating type optical elements can hardly provide a solution for inhomogeneous field of polarization either.

For the purpose of achieving the effect of inhomogeneous polarization, some people suggested methods such as optical resonance cavities and light infringement. Optical resonance cavities are applicable to incident lights of signal wavelength. The method of light infringement needs complicated and precision light-path design, which is not cost-effective either.

According to the above-mentioned, there is a need to develop an optical device having inhomogeneous polarization selectivity and the manufacturing method thereof, which is simple and cost-effective, to meet the requirements for different applications.

### SUMMARY OF THE INVENTION

To achieve the abovementioned advantages, the present invention provides an optical device having inhomogeneous polarization selectivity. The optical device includes a transparent substrate having a surface, a first optical element and a second optical element. The first and the second elements are disposed on the surface. The first optical element has a first polarization selectivity at least within a full visible frequency domain. The second optical element has a second polarization selectivity at least within a full visible frequency domain. The first and the second polarization selectivities have different orientations.

In accordance with another aspect of the present invention, an optical device is provided. The optical device includes a transparent substrate and a plurality of optical elements. Transparent substrate has a surface. The plurality of optical elements are disposed on different locations of the surface, and have a polarization selectivity at least within a full visible frequency domain. At least one of the plurality of optical elements has an orientation of the polarization selectivity different from that of another of the others, so as to form an inhomogeneous polarization field.

In accordance with a further aspect of the present invention, a method of manufacturing optical elements having a full visible frequency domain and inhomogeneous polarization selectivity is provided. The method includes steps of (a) providing a transparent substrate having a surface and (b) disposing a plurality of optical elements on different locations of the surface. Each of the plurality of optical elements has a polarization selectivity, and is disposed in accordance with a predefined orientation of the polarization selectivity.

The above objects and advantages of the present invention will be more readily apparent to those ordinarily skilled in the art after reading the details set forth in the descriptions and drawings that follow, in which:

### BRIEF DESCRIPTION OF THE DRAWINGS

FIG. 1 is a schematic diagram showing an optical device having inhomogeneous polarization selectivity in accordance with a first embodiment of the present invention;

FIG. 2 is a schematic diagram showing an optical device having inhomogeneous polarization selectivity in accordance with a second embodiment of the present invention;

FIG. 3 is a schematic diagram showing an optical device having inhomogeneous polarization selectivity in accordance with a third embodiment of the present invention;

FIG. 4 is a schematic diagram showing an optical device having inhomogeneous polarization selectivity in accordance with a fourth embodiment of the present invention;

FIG. 5 is a schematic diagram showing an optical device having inhomogeneous polarization selectivity in accordance with a fifth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

According to the basic concept of the present invention, optical devices with polarization selectivity are utilized as the fundamental elements of an assembly. The optical devices with polarization selectivity include liquid crystal, grating film, special crystal, thin-film polarizer, and etc. The cost of grating film and thin-film polarizer are lower than that of the others. It will be cost-effective to make use of grating films or thin-film polarizers to produce commercial products. For example, one may apply tensions to a transparent polymeric material coated with a layer of iodine molecules and extends the polymeric material to a thin-film. During the process of deformation of the polymeric material, the iodine molecules thereon will gradually be aligned and form a number of tiny parallel lines. The thin-film produced by the mentioned process is then becomes a polarizer having polarization selectivity within a full visible frequency domain, and can be used for sorting incident lights of a large frequency domain such as white light, visible lights and even ultra-violet lights or infrared lights. When an incident light meets the polarizer, only a portion of the incident light having an orientation of polarization consisting with the transmission axis of the polarizer is left. There are in general two types of polarizers, namely absorption type and transmission type.

Based on the concepts set forth above, the present invention make use of plural optical elements with polarization selectivity disposed on a two-dimensional space and arranged in accordance with application requirements, to produce an optical device having local polarization selectivity for electromagnetic waves at the two dimensional space. When the optical device is illuminated by a light source without polarization, polarized electromagnetic waves with the polarization in accordance with the application requirements may be obtained via either transmission or absorption. And when necessary, an optical device having inhomogeneous polarization selectivity may also been produced by the arrangement of the polarization elements, so a polarized electromagnetic wave with inhomogeneous polarization can be obtained.

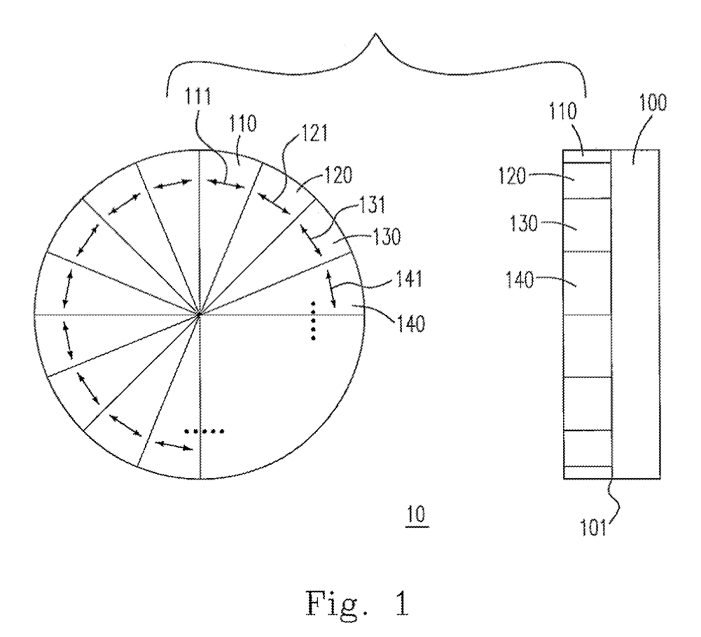

Please refer to FIG. 1, which is a schematic diagram showing an optical device having inhomogeneous polarization selectivity in accordance with a first embodiment of the present invention, the left-hand side showing a front view of the optical device 10 while the right-hand side showing a lateral view thereof. According to FIG. 1, the optical device 10 includes a transparent substrate 100 and a plurality of optical films disposed on a surface 101 of the substrate 100. For the sake of explanation, some of the optical films are indicated with reference numerals 110, 120, 130 and 140 respectively. Each of the optical films, including the optical films 110, 120, 130 and 140, has a shape of a sixteenth of a full round circle, which is identical to the shape of the transparent substrate 100. Thus, the plurality of optical films altogether compose the shape of the transparent substrate 100. Notably, the mentioned embodiment uses the round shape for example. The shape of the optical device 10 may also be a polygon or any other particular shape as per requirements. The total number of optical films is not limited to 16, and can be adjusted based on requirements too.

Referring to FIG. 1, each of the optical films, including the optical films 110, 120, 130, 140 and the ones without reference numerals, has a unique orientation of polarization selectivity whose transmission axis is indicated by a double arrow. For example, the optical films 110, 120, 130 and 140 have a transmission axis 111, 121, 131 and 141, respectively. It can be observed that, the two adjacent optical films, says 110 and 120 for instance, have different orientations of polarization. From the illustration shown in the left-hand part of FIG. 1, one skilled person in the art may also observe that those transmission axis all surround the center of the circle, so that a symmetric polarization mode can be obtained when a light originally without polarization has passed through or been reflected. The present embodiment is also named azimuthal polarization according to the knowledge known to the art. However, the present invention takes advantage of the low cost as well as easy-to-manufacture of optical films compared to the use of liquid crystal that has been known to the art.

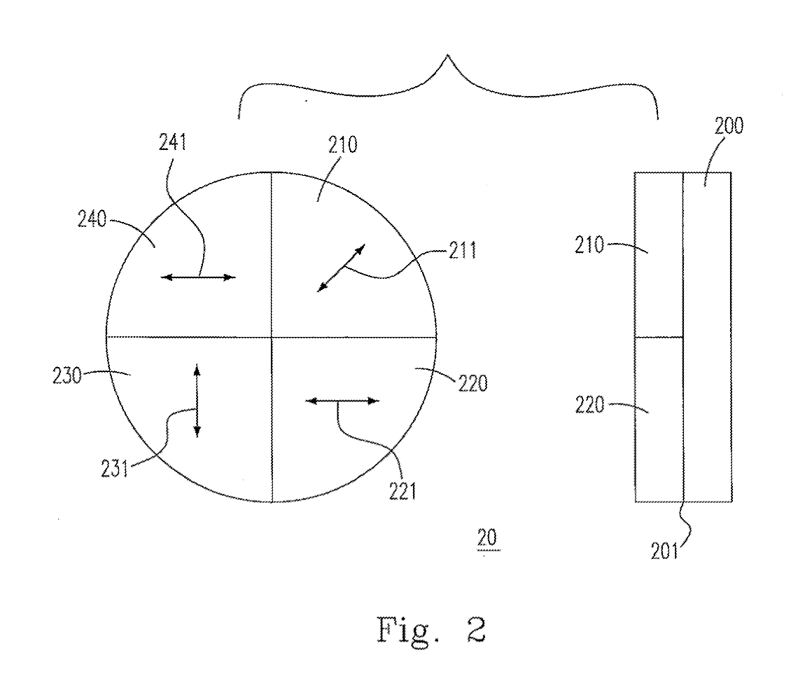

Please refer to FIG. 2, which is a schematic diagram showing an optical device having inhomogeneous polarization selectivity in accordance with a second embodiment of the present invention, the left-hand side showing a front view of the optical device 20 while the right-hand side showing a lateral view thereof. According to FIG. 2, the optical device 20 includes a transparent substrate 200 and a plurality of optical films 210, 220, 230 and 240 disposed on a surface 201 of the substrate 200. Likewise, the mentioned embodiment uses the round shape just for example. The shape of the optical device 20 may also be a polygon or any other particular shape as per requirements. The total number of optical films is not limited to 4, either. It is observed that the plurality of optical films 210, 220, 230 and 240 completely cover the transparent substrate 200. However, one may choose to use only some of the optical films to cover a portion of the substrate 200 for some particular applications that need local polarization only. Besides, the transparent substrate 200 is merely used for providing the surface 201 for disposing those optical films thereon. One may choose different tools, such as frames or other fixtures, or methods to dispose the optical films at predetermined locations if technically feasible.

Again, referring to FIG. 2, the optical films 210, 220, 230 and 240 has transmission axis 211, 221, 231 and 241, respectively, which indicates each of the optical films has a unique orientation of polarization selectivity. It can be observed that, the two adjacent optical films 210 and 220 have different orientations of polarization. Thus, the optical device 20 is able to generate an inhomogeneous and non-symmetric field of polarization for electromagnetic waves.

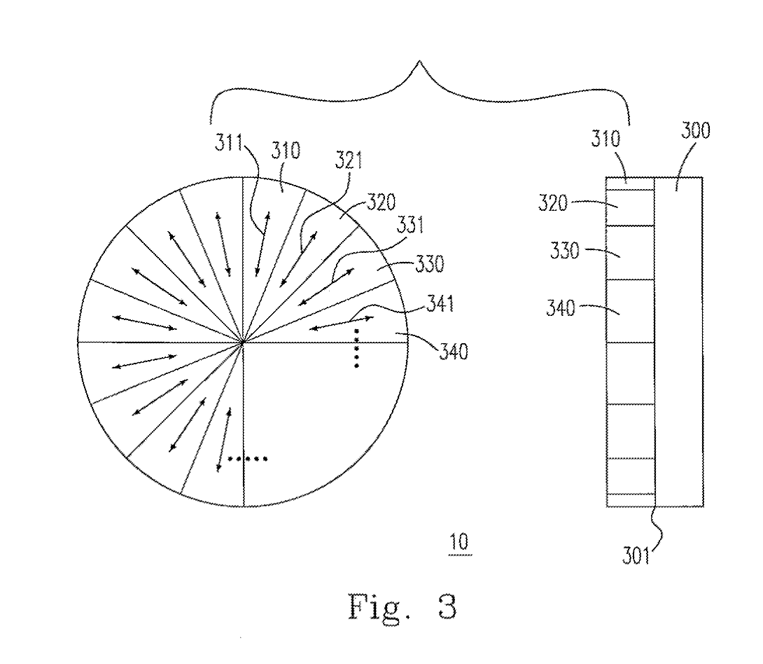

Please refer to FIG. 3, which is a schematic diagram showing an optical device having inhomogeneous polarization selectivity in accordance with a third embodiment of the present invention, the left-hand side showing a front view of the optical device 30 while the right-hand side showing a lateral view thereof. According to FIG. 3, the optical device 30 includes a transparent substrate 300 and a plurality of optical films disposed on a surface 301 of the substrate 300. For the sake of explanation, some of the optical films are indicated with reference numerals 310, 320, 330 and 340 respectively. Each of the optical films, including the optical films 310, 320, 330 and 340, has a shape of a sixteenth of a full round circle, which is identical to the shape of the transparent substrate 300. Thus, the plurality of optical films altogether compose the shape of the transparent substrate 300. Notably, the mentioned embodiment uses the round shape for example. The shape of the optical device 30 may also be a polygon or any other particular shape as per requirements. The total number of optical films is not limited to 16, and can be adjusted based on requirements too.

Referring to FIG. 3, each of the optical films, including the optical films 310, 320, 330, 340 and the ones without reference numerals, has a unique orientation of polarization selectivity whose transmission axis is indicated by a double arrow. For example, the optical films 310, 320, 330 and 340 have a transmission axis 311, 321, 331 and 341, respectively. It can be observed that, the two adjacent optical films, says 310 and 320 for instance, have different orientations of polarization. From the illustration shown in the left-hand part of FIG. 3, one skilled person in the art may also observe that those transmission axis all direct to the center of the circle, so that a symmetric polarization mode can be obtained when a light originally without polarization has passed through or been reflected. The present embodiment is also named radial polarization according to the knowledge known to the art. However, the present invention takes advantage of the low cost as well as easy-to-manufacture of optical films compared to the use of liquid crystal that has been known to the art.

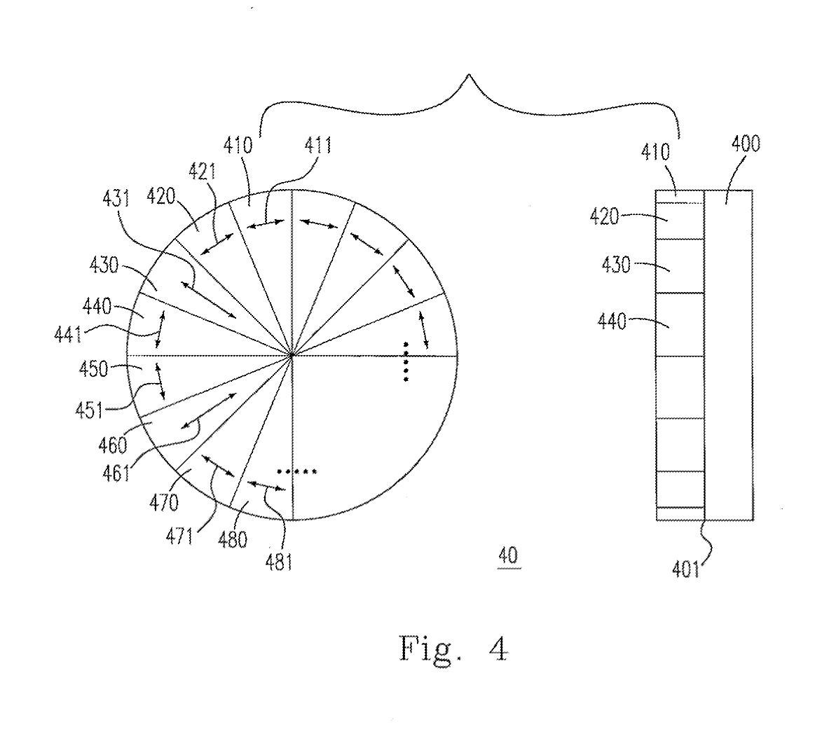

Compared with that illustrated in FIGS. 1 and 3, which provide symmetric polarization mode, the allocations of optical films can also be disposed according to a predetermined arrangement which is non-symmetric. Please refer to FIG. 4, an optical device 40 that includes optical films 410, 420, 440, 450, 470 and 480 disposed on a surface 401 of a substrate 400 have transmission axis complying with an azimuthal type, while optical films 430 and 460 have transmission axis complying with a radial type. When a light passes through the optical device 40, a non-symmetric field of polarization is formed by the selection of those optical films thereon. Consequently, a TE wave and a TM wave, which have different orientations of polarization, can occur at the same plane, which may improve the flexibility of design and application as well.

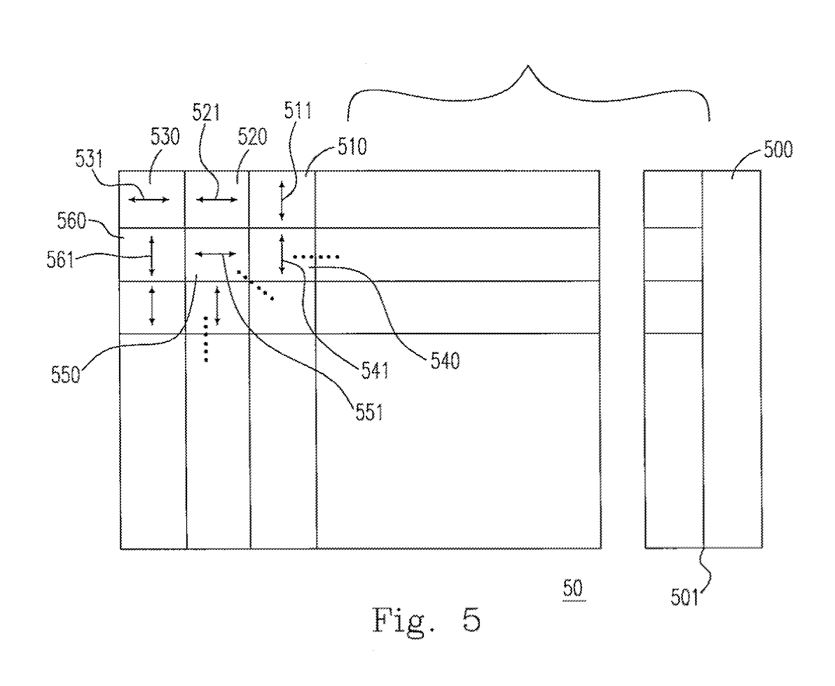

Additionally, the present invention provides more flexible embodiments to meet the ,needs of local adjustment over the polarization at a cross section when lights are propagated through the cross section. Refer to FIG. 5, which is a schematic diagram showing an optical device having inhomogeneous polarization selectivity in accordance with a fifth embodiment of the present invention. According to FIG. 5, an optical device 50 includes a transparent substrate 500 and a plurality of optical films disposed on a surface 501 of the substrate 500. For the sake of explanation, some of the optical films are indicated with reference numerals 510, 520, 530, 540, 550 and 560, and have transmission axis 511, 521, 531, 541, 551 and 561, respectively. The orientation of the transmission axis 511, 541 and 551 is vertical, while that of 521, 531 and 551 horizontal. Therefore, a non-symmetric and inhomogeneous field of polarization is formed by the selection of those optical films thereon when electromagnetic waves, such as a white light, pass through the optical device 50.

It can be observed from the illustrations in FIG. 5 that, the outer shape of the transparent substrate 50 is composed of optical elements having the same shape, each of the optical films occupies a single unit on the surface 501, and some adjacent ones of the optical films may altogether form a shape of larger dimension. For example in FIG. 5, those optical films 520, 530 and 550 with transmission axis 521, 531 and 551 along horizontal direction form an L-shape area which is surrounded by optical films with transmission axis along vertical direction. Accordingly, there exits an L-shape area with horizontal polarization mode on the surface 501 while other areas are with vertical polarization mode. Based on the abovementioned concept, one may arrange the disposition of the optical films in accordance with a predefined orientation of the polarization selectivity to form areas of different types or orientations of polarization on a two-dimension space.

The present invention provides a simple method to produce an optical device having inhomogeneous polarization selectivity with advantages such as low cost, easy to build and high design flexibility, in accordance with user's requirements. It can be implemented in a variety of applications including semiconductor manufacturing, biomedical image processing, measurement and even art design, whenever a non-homogeneous light source is required.

### Embodiments

1. An optical device having inhomogeneous polarization selectivity, comprising:
a transparent substrate having a surface;
a first optical element having a first polarization selectivity at least within a full visible frequency domain, and disposed on the surface; and
a second optical element having a second polarization selectivity at least within a full visible frequency domain, and disposed on the surface, wherein the first and the second polarization selectivities have different orientations.

2. The optical device of embodiment 1 wherein the transparent substrate has a shape of one selected from a group consisting of a round, a square and a polygon.

3. The optical device of embodiment 2 wherein the first and the second optical elements have a same shape.

4. The optical device of embodiment 1 wherein at least one of the first and the second optical elements includes an iodine.

5. The optical device of embodiment 1, wherein at least one of the first and the second optical elements has an optical grating.

6. The optical device of embodiment 1 wherein at least one of the first and the second optical elements is a thin-film polarizer.

7. The optical device of embodiment 6, wherein the first and the second optical elements are absorption polarizers.

8. The optical device of embodiment 6, wherein the first and the second optical elements are reflection polarizers.

9. An optical device, comprising:
a transparent substrate having a surface; and
a plurality of optical elements disposed on different locations of the surface, and having a polarization selectivity at least within a full visible frequency domain, wherein at least one of the plurality of optical elements has an orientation of the polarization selectivity different from that of another of the others, so as to form an inhomogeneous polarization field.

10. The optical device of embodiment 9 wherein at least one of the plurality of optical elements has an optical grating.

11. The optical device of embodiment 9 wherein at least one of the plurality of optical elements is a thin-film polarizer.

13. The optical device of embodiment 9 wherein at least one of the plurality of optical elements is an absorption polarizer.

14. The optical device of embodiment 9 wherein at least one of the plurality of optical elements is a reflection polarizer.

15. The optical device of embodiment 9 wherein the transparent substrate has a shape, and the plurality of optical elements are disposed on the surface in a way to compose the shape.

16. The optical device of embodiment 9 wherein the plurality of optical elements have a same shape.

17. The optical device of embodiment 9 wherein each of the plurality of optical elements is disposed in accordance with a predefined orientation of the polarization selectivity.

18. A method of manufacturing optical elements having a full visible frequency domain and inhomogeneous polarization selectivity, comprising steps of:
providing a transparent substrate having a surface; and
disposing a plurality of optical elements on different locations of the surface, wherein each of the plurality of optical elements has a polarization selectivity, and is disposed in accordance with a predefined orientation of the polarization selectivity.

19. The method of embodiment 18 wherein each of the optical elements is one of an absorption polarizer and a refection polarizer.

20. The method of embodiment 18 wherein each of the optical elements has an optical grating.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. An optical device having inhomogeneous polarization selectivity, comprising:
a transparent substrate having a surface;
a first optical element having a first polarization selectivity at least within a full visible frequency domain, and disposed on the surface; and
a second optical element having a second polarization selectivity at least within a full visible frequency domain, and disposed on the surface, wherein the first and the second polarization selectivities have different orientations.

2. An optical device as claimed in claim 1, wherein the transparent substrate has a shape of one selected from a group consisting of a round, a square and a polygon.

3. An optical device as claimed in claim 2, wherein the first and the second optical elements have a same shape.

4. An optical device as claimed in claim 1, wherein at least one of the first and the second optical elements includes an iodine.

5. An optical device as claimed in claim 1, wherein at least one of the first and the second optical elements has an optical grating.

6. An optical device as claimed in claim 1, wherein at least one of the first and the second optical elements is a thin-film polarizer.

7. An optical device as claimed in claim 6, wherein the first and the second optical elements are absorption polarizers.

8. An optical device as claimed in claim 6, wherein the first and the second optical elements are reflection polarizers.

9. An optical device, comprising:
a transparent substrate having a surface; and
a plurality of optical elements disposed on different locations of the surface, and having a polarization selectivity at least within a full visible frequency domain, wherein at least one of the plurality of optical elements has an orientation of the polarization selectivity different from that of another of the others, so as to form an inhomogeneous polarization field.

10. An optical element as claimed in claim 9, wherein at least one of the plurality of optical elements has an optical grating.

11. An optical element as claimed in claim 9, wherein at least one of the plurality of optical elements is a thin-film polarizer.

13. An optical element as claimed in claim 9, wherein at least one of the plurality of optical elements is an absorption polarizer.

14. An optical element as claimed in claim 9, wherein at least one of the plurality of optical elements is a reflection polarizer.

15. An optical element as claimed in claim 9, wherein the transparent substrate has a shape, and the plurality of optical elements are disposed on the surface in a way to compose the shape.

16. An optical element as claimed in claim 9, wherein the plurality of optical elements have a same shape.

17. An optical element as claimed in claim 9, wherein each of the plurality of optical elements is disposed in accordance with a predefined orientation of the polarization selectivity.

18. A method of manufacturing optical elements having a full visible frequency domain and inhomogeneous polarization selectivity, comprising steps of:
providing a transparent substrate having a surface; and
disposing a plurality of optical elements on different locations of the surface, wherein each of the plurality of optical elements has a polarization selectivity, and is disposed in accordance with a predefined orientation of the polarization selectivity.

19. A method as claimed in claim 18, wherein each of the optical elements is one of an absorption polarizer and a refection polarizer.

20. A method as claimed in claim 18, wherein each of the optical elements has an optical grating.
